(19) United States
(12) Patent Application Publication
(10) Pub. No.: US 2014/0160499 A1
(43) Pub. Date: Jun. 12, 2014

(54) MAGE FORMING APPARATUS, CONTROL METHOD THEREOF, AND STORAGE MEDIUM

(71) Applicant: CANON KABUSHIKI KAISHA, Tokyo (JP)

(72) Inventor: Nobushige Nomura, Chigasaki-shi (JP)

(73) Assignee: CANON KABUSHIKI KAISHA, Tokyo (JP)

(21) Appl. No.: 14/098,236

(22) Filed: Dec. 5, 2013

(30) Foreign Application Priority Data
Dec. 7, 2012 (JP) 2012-268362

(51) Int. Cl. G06K 15/02; H04N 1/60

(52) U.S. Cl. CPC G06K 15/02; H04N 1/60
USPC 358/1.9

(57) ABSTRACT

An image forming apparatus is capable of generating a color image according to an image processing request for execution of image processing on a document being read and computerized, and also capable of reducing a consumption amount of developing material to print a background image. A control method for controlling an image forming apparatus includes reading an image of a document, recognizing a background color of the read image, storing image data indicating the read image and the recognized background color, receiving a processing request for execution of processing on the stored image data, and controlling execution of processing on the image data according to the received processing request and the stored background color.

### BACKGROUND OF THE INVENTION

1. Field of the Invention

The present invention relates to an image forming apparatus, a control method, and a storage medium.

2. Description of the Related Art

In recent years, it has become popular to create paper documents printed in color by use of an image forming apparatus, and color printed products and paper documents using colored sheets are widely used. The paper documents thus created are stored or distributed as they are, or electronically filed by a scanner or the like and stored. The electronic file may be distributed or printed.

However, when an image forming apparatus prints data that is electronically filed by scanning a paper document using a colored sheet, the scanned image includes the color of the sheet as a part of the image on the electronic file. Thus, even if a colored sheet having the same color as that of the colored sheet of the original paper document is prepared at the image forming apparatus, the scanned image including the color of the colored sheet is printed together with the read background color on the colored sheet.

In view of the foregoing, Japanese Patent in which when a paper document is computerized, sheet color information for each page is preregistered, or areas on which sheet color determination is to be executed at the time of scanning are designated to remove the determined sheet color from the scanned image. Japanese Patent Application Laid-Open No. 2002-300346 also discusses a facsimile apparatus in which the sheet color of each page is transmitted to an image forming apparatus as data to print on a sheet that is appropriate for the sheet color of the paper document.

However, when an electronic file of a paper document is displayed on a screen of a personal computer (PC) or the like, if the sheet color of the paper document, which has a specific meaning, is removed from the image of the electronic file, the original sheet color cannot be recognized on the screen. In such cases, since the electronic file may mislead a receiver of the electronic file, it is not appropriate to remove the sheet color from the electronic file. On the other hand, when the sheet color is not removed from the electronic file, the image forming apparatus fills a colored sheet using a recording material of the sheet color recorded on the electronic file, even if the colored sheet having the same color as that of the original paper document is prepared at the image forming apparatus. This leads to excess consumption of recording material.

### SUMMARY OF THE INVENTION

According to an aspect of the present invention, an image forming apparatus includes a reading unit configured to read an image of a document, a recognizing unit configured to recognize a background color of the image read by the reading unit, a storage unit configured to store image data indicating the image read by the reading unit and the background color recognized by the recognizing unit, a receiving unit configured to receive a processing request for execution of processing on the image data stored in the storage unit, and a control unit configured to control execution of processing on the image data according to the processing request received by the receiving unit and the background color stored in the storage unit.

Further features of the present invention will become apparent from the following description of exemplary embodiments with reference to the attached drawings.

### BRIEF DESCRIPTION OF THE DRAWINGS

FIG. 1 is a cross-sectional view illustrating a configuration of an image forming apparatus.

FIG. 2 is a view illustrating a user interface (UI) screen to be displayed on a display panel of an operation unit illustrated in FIG. 1.

FIG. 3 is a view illustrating a UI screen to be displayed on the display panel of the operation unit illustrated in FIG. 1.

FIG. 4 is a block diagram illustrating a detailed configuration of a controller illustrated in FIG. 1.

FIG. 5 is a flow chart illustrating a method of controlling an image forming apparatus.

FIGS. 6A and 6B are views illustrating an example of processing to generate a background image from a scanned image.

FIG. 7 is a flow chart illustrating a method of controlling an image forming apparatus.

FIG. 8 is a flow chart illustrating a method of controlling an image forming apparatus.

FIG. 9 is a flow chart illustrating a method of controlling an image forming apparatus.

### DESCRIPTION OF THE EMBODIMENTS

Various exemplary embodiments, features, and aspects of the invention will be described in detail below with reference to the drawings.

Description of System Configuration

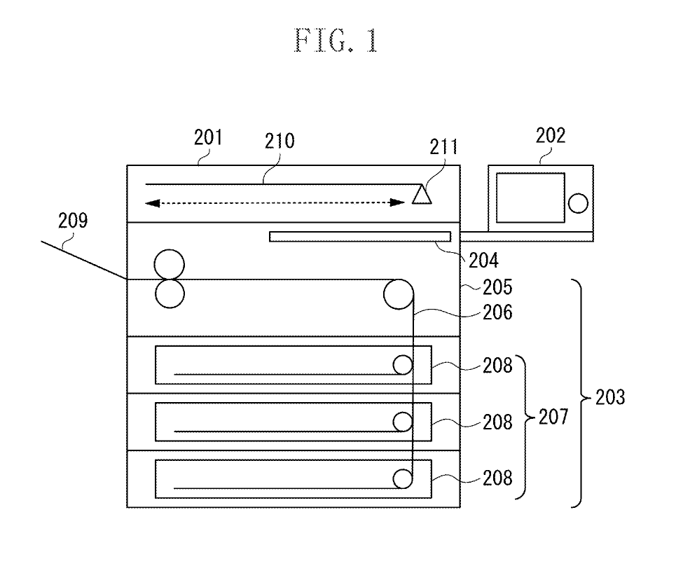

FIG. 1 is a cross sectional view illustrating a configuration of an image forming apparatus according to an exemplary embodiment of the present invention. In the present exemplary embodiment, a multi function image forming apparatus (multifunction peripheral (MFP)) will be described as an example of the image forming apparatus.

In FIG. 1, the image forming apparatus according to the present exemplary embodiment includes an image reading apparatus 201, an operation unit 202, a printing apparatus 203, and a controller 204, which collectively constitute the MFP.

The image reading apparatus 201 includes a document positioning plate 210 and a scanner unit 211 arranged under the document positioning plate 210. The document positioning plate 210, on which a document to be read is positioned, is made of a transparent material such as glass. The scanner unit 211 includes, for example, a charge coupled device (CCD) and a light source. The scanner unit 211 is capable of reading the entire document positioning plate 210 while moving. The CCD reads a reflected light image from a document according to reading conditions specified by a scanner control unit 303, which will be described below, and the image reading apparatus 201 transmits the scanned image to a memory 302, which will be described below.

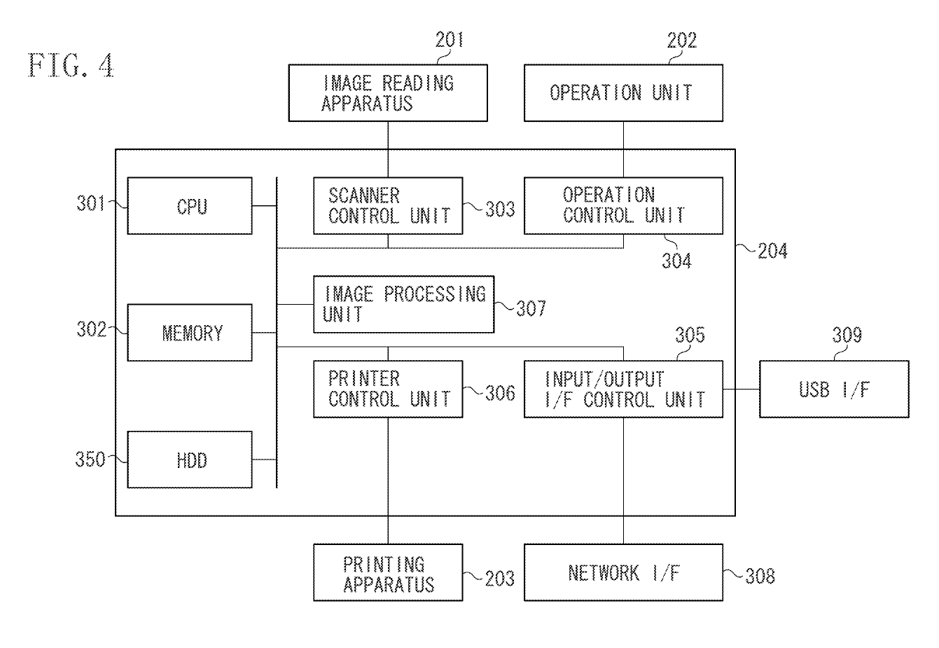

The operation unit 202 includes a display panel such as a liquid crystal display panel displaying information to users, and buttons and a touch panel detecting user inputs. An operation control unit 304, illustrated in FIG. 4, enables the touch panel to display arbitrary images that are necessary for MFP operation, such as a feeding tray designation button and a start button. The operation control unit 304 is capable of detecting inputs made via the touch panel or hard keys of the operation unit 202 to notify a central processing unit (CPU) 301, which will be described below, of the inputs.

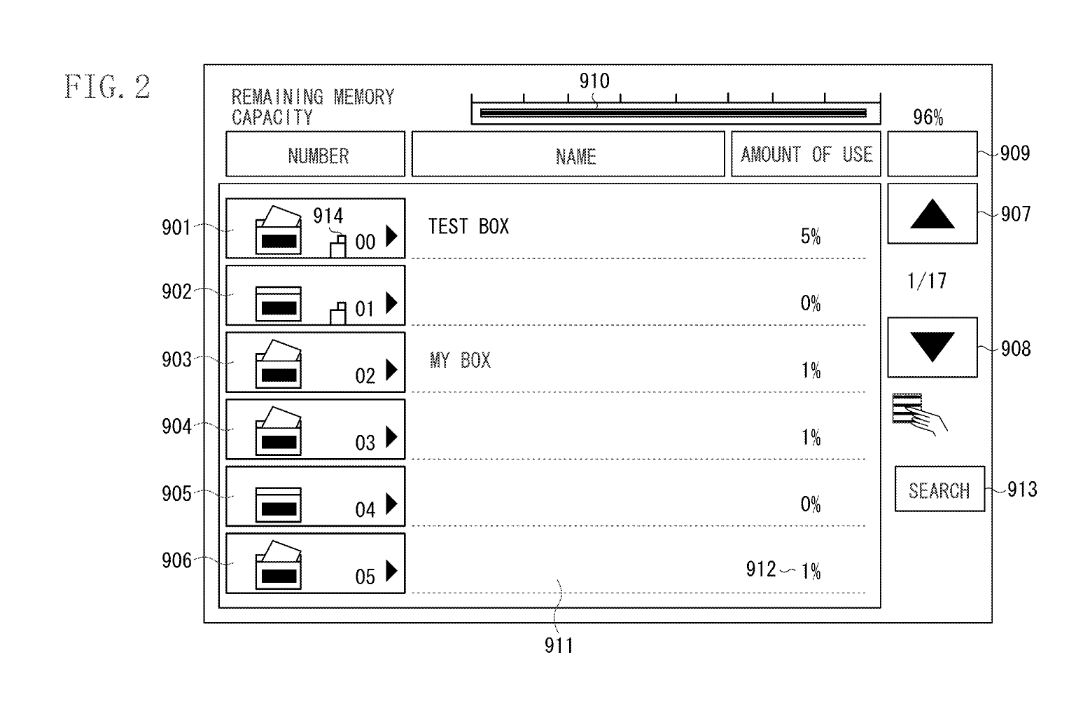

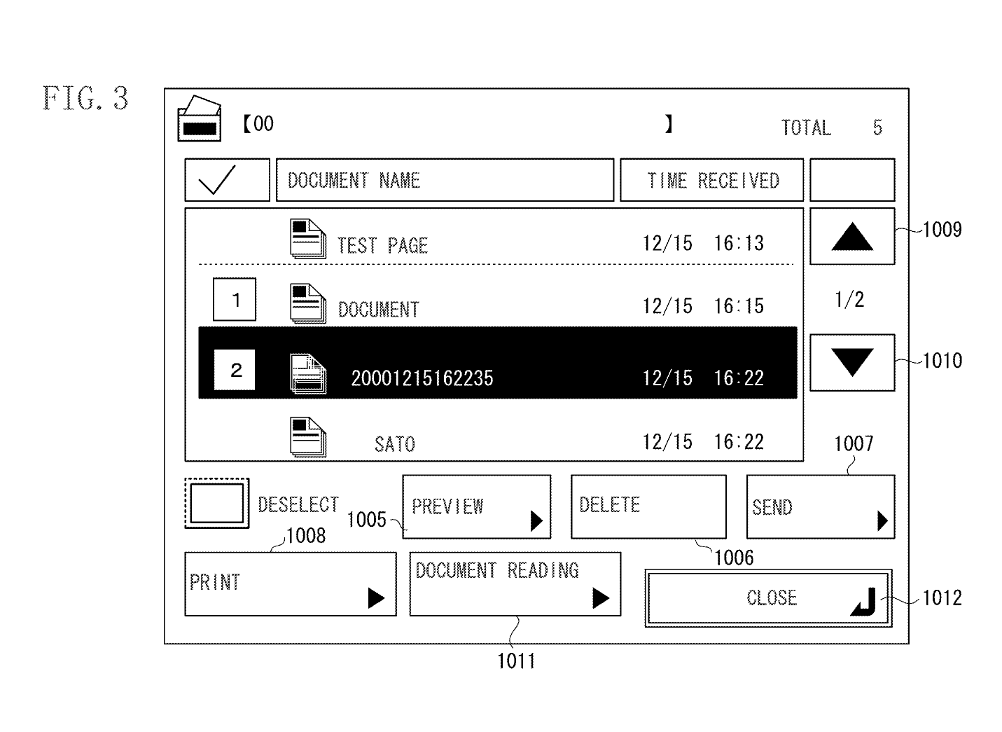

FIGS. 2 and 3 are views illustrating UI screens to be displayed on the display panel of the operation unit 202 illustrated in FIG. 1. These examples correspond to a box area storage list screen stored in a box area reserved in the memory 302, which will be described below. FIG. 2 corresponds to an initial screen for storage function processing of the box area.

The initial screen illustrated in FIG. 2 is displayed when an user presses a box function key. Buttons 901, 902, 903, 904, 905, and 906 are for displaying box content for displaying image data stored in boxes of box numbers 00, 01, 02, 03, 04, and 05, respectively. In the buttons 901 to 906, an image as illustrated in a frame of the button 901, 903, 904, or 906 is displayed when its corresponding box stores image data. On the other hand, when its corresponding box stores no image data, an image illustrated in a frame of the button 902 or 905 is displayed. Thus, a user can immediately identify boxes storing image data. Further, when a password is set to a box, an image 914 is provided within the button frame. Thus, a user can immediately identify boxes to which a password is set.

A field 911 displays a name given to each box. A field 912 displays a percentage of usage of each box to hard disk capacity of corresponding box area. For example, if the hard disk capacity of the box area is 500 MB, “5%” in the box of box number 00 indicates that the box is using about 25 MB, which is 5% of 500 MB. Further, a user can press an up scroll key 907 or a down scroll key 908 to scroll the screen so that the user can see the name and the percentage of use of a box that is not displayed on the screen. A remaining memory capacity display field 909 displays the percentage of remaining memory capacity of the box area. A remaining memory capacity display bar 910 shows the remaining memory capacity in the form of a bar graph.

A search key 913 is for searching for image data stored in the boxes. When a user presses the search key 913, a search is executed, which will be described below. If the user already knows a box that stores target image data, the user only needs to press the key of the corresponding box on the screen illustrated in FIG. 2. If the user does not known which box stores target image data or wants any image data that satisfies certain conditions, the user can press the search key 913 to execute searching.

The following describes operations executed when a user presses the buttons 901 to 906. When the user presses one of the buttons 901 to 906, information of image data stored in the corresponding box is displayed. Alternatively, the user can designate a box number via a numeric keypad included in the operation unit 202 so that the content of the corresponding box is displayed.

If a password is set to a box, the operation unit 202 displays a password input screen. For example, when a user presses the button 901 in the basic screen illustrated in FIG. 2, the operation unit 202 displays a password input screen, which is not illustrated. The user inputs a password via the numeric keypad and then presses an OK key. If the input password matches a preregistered password, information of image data stored in the box is displayed. If the input password does not match the preregistered password, information of image data stored in the box is not displayed.

In the present exemplary embodiment, the UI screen illustrated in FIG. 2 is the initial screen for box function processing. When the user selects a box on the initial screen by pressing one of the buttons 901 to 906, the initial screen shifts to a document display screen in the corresponding box as illustrated in FIG. 3. A document reading button 1011 displayed on the document display screen is a button for reading a new document to store an image of the document in the box. A print button 1008 is a button for printing a selected image. A preview button 1005 is a button for displaying a preview of the selected image. A send button 1007 is a button for sending the selected image to an external apparatus. A button 1012 is to close the UI screen illustrated in FIG. 3. Buttons 1009 and 1010 are scroll buttons.

The printing apparatus 203 includes a printing unit 205, a sheet conveyance path 206, a sheet feeding unit 207 including a plurality of sheet feeding trays 208, and a sheet discharge tray 209. A sheet is sent from the sheet feeding unit 207 designated by a printer control unit 306 to the printing unit 205 via the sheet conveyance path 206. The printing unit 205 prints a print image that has been converted by an image processing unit 307 on the sheet, and discharges the sheet to the sheet discharge tray 209. While an electrophotographic method, in which an image is formed with toner by use of a photosensitive member or a photosensitive belt, is described as an example of a printing method used by the printing unit 205, any other method can also be used.

FIG. 4 is a block diagram illustrating a detailed configuration of the controller 204 illustrated in FIG. 1.

In FIG. 4, the controller 204 includes the CPU 301, the memory 302, the scanner control unit 303, the operation control unit 304, an input/output interface (I/F) control unit 305 controlling a network I/F 308 and a universal serial bus (USB) I/F 309, the printer control unit 306, and the image processing unit 307. A hard disk drive (HDD) 350, which reserves a box area for each user, stores and manages electronic files that are generated by scanning and stored in the box area through a UI screen, which will be described below. Further, the user can check a list of electronic files or see a preview of a selected file on the operation unit 202 by operating the UI screen displayed on the operation unit 202 as illustrated in FIG. 3. The user presses the preview button 1005 on the UI screen illustrated in FIG. 3 to see a preview of an image of a selected electronic file on the operation unit 202. In the present exemplary embodiment, scanned image data is in its original state. Specifically, when an object printed on a colored sheet is scanned, a background image is also captured. Thus, an original scanned image can be transmitted in a transmission job or the like. Specifically, whether an attribute of a processing request for execution of processing on an electronic file stored in the HDD 350 is a display request, a transmission request, or a print request is determined. Depending on a result of the determination, execution of image processing on the electronic file may become necessary with the request, or the electronic file may directly be processed.

The CPU 301 is a processor controlling the entire MFP system. The memory 302 includes a work memory for the CPU 301 to operate, a storage memory to be used by each control unit, a program area storing various programs for system control. The scanner control unit 303 controls the image reading apparatus 201 based on sheet size information designated by the operation unit 202 or a control program, and transmits an acquired image to an image memory of the memory 302.

The operation control unit 304 controls displays shown on the operation unit 202 and also controls operation inputs made via the buttons, the touch panel, or the like. The operation control unit 304 also controls changes of screen displays in response to operation inputs. The operation control unit 304 is capable of returning a response about whether an input has been made, a response about whether a set value has been changed, and a response regarding a set value. The input/output I/F control unit 305 reads and writes files to storages connected via the network I/F 308 or the USB I/F 309. The printer control unit 306 designates a sheet feeding tray and controls the printing apparatus 203 to print a print image generated by the image processing unit 307.

The image processing unit 307 includes image processing units for such as image analysis, color conversion, format conversion, and image size recognition. The image processing unit 307 creates an electric file from a scanned image generated by the scanner control unit 303. The image processing unit 307 also executes image processing on a scanned image or an electronic file input via the input/output I/F control unit 305 to convert the scanned image or the electronic file into an image that is printable through the printer control unit 306.

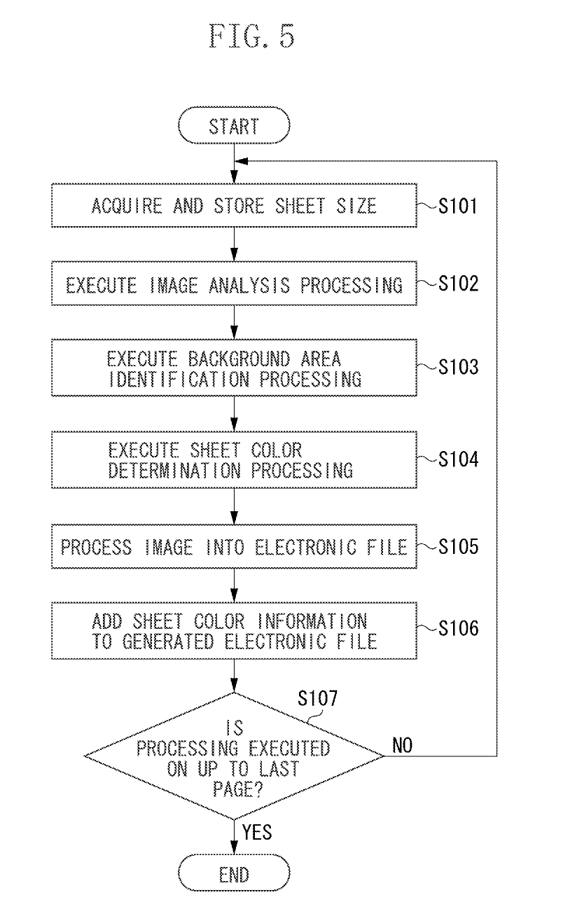

The following describes an operation of the image processing unit 307 with regard to a flow of computerization of a paper document including a colored sheet according to the present exemplary embodiment, with reference to a flow chart illustrated in FIG. 5.

FIG. 5 is the flow chart illustrating a method of controlling the image forming apparatus according to the present exemplary embodiment. The present exemplary embodiment is an example of computerization processing of a paper document including a colored sheet performed by the CPU 301 illustrated in FIG. 4 with controlling the image processing unit 307. The CPU 301 loads a control program into the memory 302 and causes the image processing unit 307 to execute the control program to realize each step.

Prior to the execution of the processing illustrated in FIG. 5, the scanner control unit 303 reads a paper document including a colored sheet that is positioned on the image reading apparatus 201 under designated reading conditions and stores the scanned image in the memory 302.

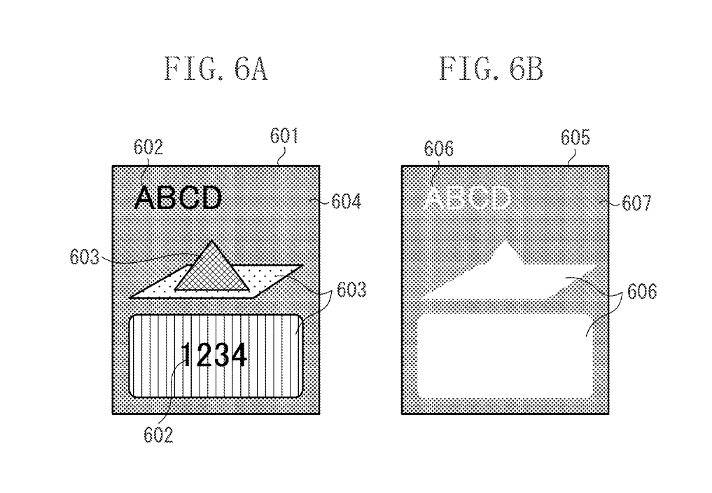

FIGS. 6A and 6B are views illustrating an example of processing of generating a background image from a scanned image read by the image reading apparatus 201 illustrated in FIG. 1. FIG. 6A is an example of the scanned image.

In FIG. 6A, a scanned image 601 includes character portions 602, graphic portions 603, and a portion where the character portions 602 and the graphic portions 603 overlap each other. A portion 604 is a scanned portion of the color of the sheet. The image processing unit 307 repeats execution of the following processing on each page of a scanned image under the control of the CPU 301.

In step S101, the image processing unit 307 acquires a sheet size of the paper document based on the number of vertical and horizontal dots of the scanned image 601 and stores the sheet size in the memory 302.

Next, in step S102, the image processing unit 307 executes image analysis processing on the scanned image 601. Specifically, the image processing unit 307 executes object recognition processing on the scanned image 601 and generates information of recognized objects such as the character portions 602 and the graphic portions 603 as a document object list to be stored in the memory 302.

The generated document object list includes position information to specify the occupying area of each object in the document. To execute the processing, the image processing unit 307 can use any publicly-known object recognition technique. For example, a technique discussed in Japanese Patent Application Laid-Open No. 2011-54123 can be used.

Next, in step S103, the image processing unit 307 executes background identification processing to identify an area as a background area in which no object is included from the scanned image 601 based on the sheet size and the document object list of the scanned image 601.

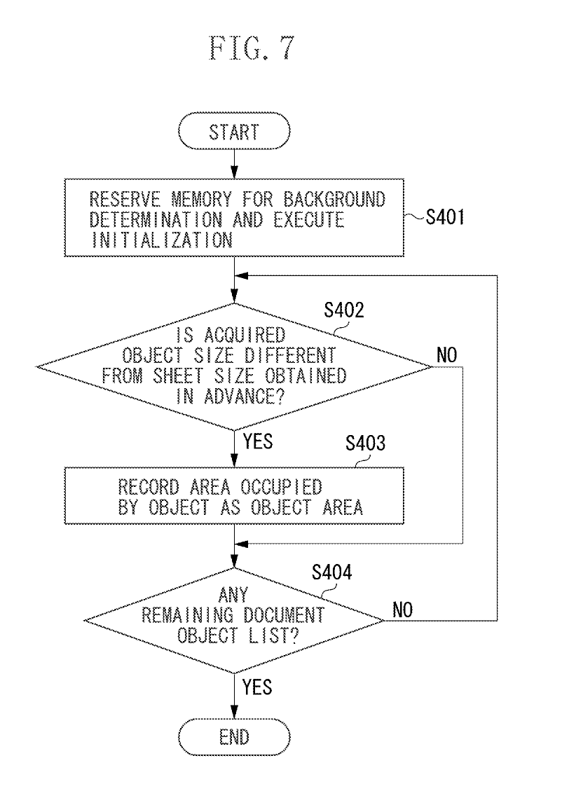

The following describes the background identification processing with reference to FIGS. 6B and 7.

FIG. 7 is a flow chart illustrating a method of controlling the image forming apparatus according to the present exemplary embodiment. The image processing unit 307 according to the present exemplary embodiment identifies an area as a background area in which no object is included from the scanned image 601 based on the sheet size and the document object list of the scanned image 601. The following is an example of the background identification processing executed by the image processing unit 307. The CPU 301 loads a control program into the memory 302 and causes the image processing unit 307 to execute the control program to realize each step.

In step S401, the image processing unit 307 reserves a memory 605 for background determination in the memory 302 and initializes the entire image as a background. The memory 605 for background determination indicates whether each dot within a sheet size is included in the background image or in the object image. FIG. 6B illustrates a state of the memory 605 for background determination, showing object areas 606 recognized as object areas and a background area 607 recognized as a background area as a result of the processing executed on the scanned image 601 illustrated in FIG. 6A.

Next, in step S402, the image processing unit 307 acquires the object size from the document object list and compares the acquired object size with the sheet size of the scanned image 601 obtained in advance. If the image processing unit 307 determines that the acquired object size is the same as the sheet size, this object is excluded from targets of the background determination, because the entire background may have been recognized as one object. Then, the processing proceeds to step S404.

In step S402, if the image processing unit 307 determines that the acquired object size is not the same as the sheet size, the processing proceeds to step S403. In step S403, the image processing unit 307 fixes occupied areas by objects in the scanned image 601 from the document object list, and records the corresponding areas in the memory 605 for background determination as the object areas 606.

Then, in step S404, the image processing unit 307 determines whether there is any remaining document object in the document object list. If the image processing unit 307 determines that there is a remaining document object in the document object list, the image processing unit 307 returns to step S402 to repeat execution of the processing on all document objects on the page.

When the image processing unit 307 has completed the execution of the processing on all document objects in the document object list (YES in step S404), the processing proceeds to end. At the time, the area, which is recorded as the background area 607 in the memory 605 for background determination, is finalized as the background area including no object on the sheet, whereby the background identification processing is realized.

The description of the processing illustrated in FIG. 5 is resumed as follows.

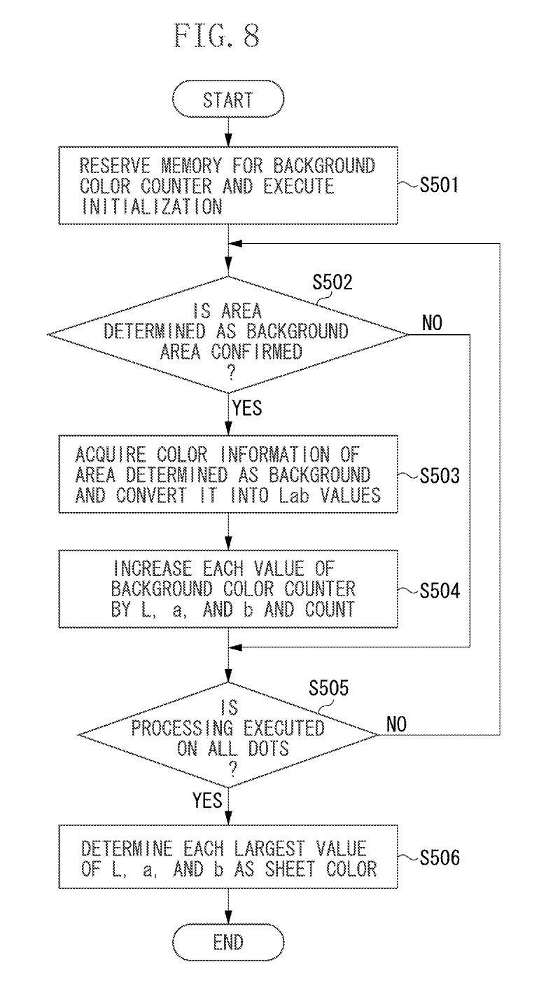

In step S104, the image processing unit 307 executes sheet color determination processing to determine pixel characteristics of the color of the sheet based on the scanned image 601 and the memory 605 for background determination and extract the background color. The following describes the sheet color determination processing with reference to FIG. 8.

FIG. 8 is a flow chart illustrating a method of controlling the image forming apparatus according to the present exemplary embodiment. The present exemplary embodiment is an example of the sheet color determination processing in which the image processing unit 307 determines the color of a sheet. The CPU 301 loads a control program into the memory 302 and causes the image processing unit 307 to execute the control program to realize each step.

In step S501, the image processing unit 307 reserves a memory for a background color counter in the memory 302 to record the color distribution of background pixels, and executes initialization. The background color counter counts the appearing number of each element of the Lab color space. Next, in step S502, the image processing unit 307 confirms an area determined as the background area 607 by scanning the memory 605 for background determination. If the image processing unit 307 determines that the area is not a background area (NO in step S502), the processing proceeds to step S505.

If the image processing unit 307 determines that the area is a background area (YES in step S502), the image processing unit 307 acquires color information of the area determined as the background from the scanned image 601, in step S503. Colors on the scanned image 601 read from the image reading apparatus 201 are expressed in RGB space. Thus, in step S503, the color is converted into values in Lab space. The conversion formula from RGB values to Lab values is defined in advance in the image processing unit 307.

In step S504, the image processing unit 307 increases each corresponding value of the background color counter by L, a, and b with acquired color information and counts. If there are any dots to be executed remained (NO in step S505), the image processing unit 307 returns to step S502. The image processing unit 307 repeats the processing so that the processing is executed on all dots on the memory 605 for background determination. In step S506, when the values of all dots are counted, each largest value of L, a, and b is determined as sheet color, whereby the sheet color determination processing is realized.

The description of the flow chart illustrated in FIG. 5 is resumed as follows.

In step S105, after the determination of the sheet color, the image processing unit 307 processes the scanned image 601 into an electronic file according to an output format such as Portable Document Format (PDF (registered trademark)) and PowerPoint (registered trademark).

Next, in step S106, the image processing unit 307 adds the sheet color information of the corresponding page determined in the sheet color determination processing to the generated electronic file. The image processing unit 307 records the sheet color information in data according to an output format. As to a recording method, for example, a method uniquely extending the comment description designated by a target format may be used for recording.

In step S107, the image processing unit 307 determines whether the foregoing processing is executed up to the last page of the document. If the image processing unit 307 determines that the processing is not repeated up to the last page (NO in step S107), the image processing unit 307 returns to step S101. If the image processing unit 307 determines that the processing is repeated up to the last page (YES in step S107), the image processing unit 307 ends the processing.

The foregoing processing enables the image processing unit 307 to automatically add the sheet color information to each page of the electronic file when the colored paper document is computerized.

From the electronic file list (document name) stored in the box area of the HDD 350 in the UI screen illustrated in FIG. 3, a user can select a file to preview or send. For example, if a user selects a file from the list displayed on the UI screen illustrated in FIG. 3 and then selects the preview button 1005, the user can see a preview of the selected file in the original state as a color sheet image on the display unit of the operation unit 202.

Similarly, for example, if a user selects a file from the list displayed on the UI screen illustrated in FIG. 3 and then selects a send button 1007, the user can send the selected file in the original state as a color sheet image to a destination according to transmission settings.

In other words, the electronic data is stored in the box without removing the color of the background of the document so that a user can see a preview image having the color of the background of the document or transmit an image having the color of the background of the document to an external apparatus.

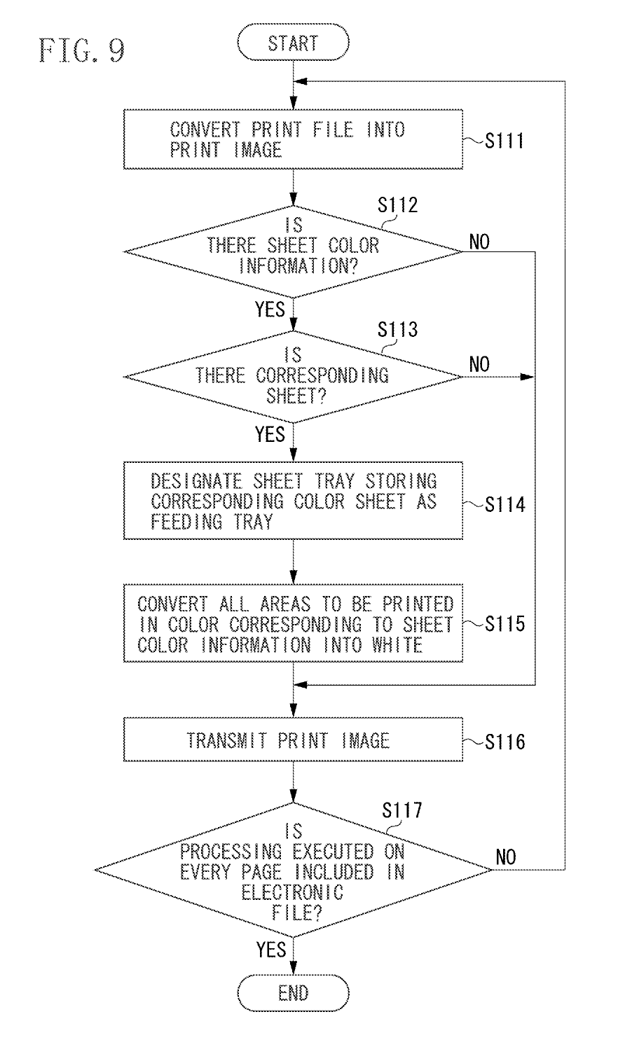

FIG. 9 is a flow chart illustrating a method of controlling the image forming apparatus according to the present exemplary embodiment. The present exemplary embodiment is an example of processing executed by the image processing unit 307 when an electronic file with sheet color information is input so that the image processing unit 307 automatically selects the corresponding color sheet and executes printing. The CPU 301 loads a control program into the memory 302 and causes the image processing unit 307 to execute the control program to realize each step. In the image forming apparatus according to the present exemplary embodiment, the printer control unit 306 stores sheet type information that can be used in the apparatus, and the sheet type information includes information about the color of the sheet.

The information of sheets placed in each sheet feeding tray 208 is recorded in the memory 302 such that the information is associated with a sheet feeding tray number by a sensor (not illustrated) in the sheet feeding unit 207 or user operation input via the operation unit 202.

Prior to the execution of the processing illustrated in FIG. 9, the input/output I/F control unit 305 receives an electronic file from the network I/F 308 or the USB I/F 309 and stores the received electronic file in the memory 302.

In step S111, the image processing unit 307 identifies the format of a print file stored in the memory 302, and converts the file content into a print image to be printed on a sheet through the printer control unit 306. Next, in step S112, the image processing unit 307 checks whether there is sheet color information in the print file. If the image processing unit 307 determines that there is no sheet color information (NO in step S112), the image processing unit 307 proceeds to step S116.

In step S112, if the image processing unit 307 determines that there is sheet color information (YES in step S112), the image processing unit 307 proceeds to step S113. In step S113, the image processing unit 307 compares the color information of sheets in each sheet feeding tray that is stored in the memory 302 with the sheet color information of the print page obtained from the print file, and determines whether there is a corresponding sheet. In this sheet color comparison processing, the image processing unit 307 makes a determination based on whether values of the color information match the color information included in the sheet type information recorded in the printer control unit 306 or whether values of the color information preset to the image processing unit 307 are within a color difference range.

Further, appropriate color ranges (such as allowable values for L, a, and b) may be included in the sheet type information so that the image processing unit 307 can determine that a sheet is a corresponding sheet if the sheet color information of the sheet is within the ranges. If the image processing unit 307 determines that there is no corresponding color sheet in the sheet feeding trays, the image processing unit 307 expects printing on a white paper and proceeds to step S116.

While the flow chart in FIG. 9 does not illustrate, the image processing unit 307 may display information on the operation unit 202 via the operation control unit 304 indicating that there is no corresponding color sheet in the sheet feeding trays to prompt a user to insert the corresponding color sheet in any of the sheet feeding trays.

If insertion of the corresponding color sheet into a sheet feeding tray by the user is detected through operation of the operation unit 202, the image processing unit 307 proceeds to step S114. If an operation changing a sheet to be fed is not conducted for a predetermined period or the user selects printing on a white paper via the operation unit 202, the image processing unit 307 proceeds to step S116.

Next, in step S114, the image processing unit 307 designates the printer control unit 306 to feed a sheet from a sheet feeding tray storing the corresponding color sheets when a page being processed is printed.

In step S115, the image processing unit 307 converts all areas of the print image that are to be printed in a color corresponding to the sheet color information into white (white pixel). Not only areas that match the values of sheet color information but also areas that can be determined as having similar color are converted into white. The similarity of color can be determined by, for example, determining whether each of the L, a, and b values of color sheet information is within a margin range preset by the image processing unit 307.

Next, in step S116, the image processing unit 307 transmits the print image to the printer control unit 306 so that the printer control unit 306 prints the print image through the printing apparatus 203.

Next, in step S117, the image processing unit 307 determines whether the foregoing processing is executed on every page included in the electronic file. If the image processing unit 307 determines that the processing is not executed on every page included in the electronic file (NO in step S117), the image processing unit 307 returns to step S111 to repeat the processing so that the corresponding color sheet can automatically be selected from the print image.

As described above, the image analysis processing is executed on an input image to delete objects on a sheet so that the sheet color of the document can automatically be recognized. Further, sheet color information is incorporated into a generated electronic file so that the most appropriate color sheet can automatically be selected by reference to the sheet color information on the electronic file at the time of printing the electronic file. Without printing sheet color areas on the electronic file, the toner consumption can be reduced while printing.

While the above exemplary embodiment of the present invention is described on the assumption that an electronic file is to be printed and a process in which a document including a color sheet is read to generate an electronic file is executed separately from a process in which the generated electronic file is printed. However, the present invention is not limited to the exemplary embodiment.

For example, even when a single apparatus executes copying operation of document computerization and printing, if the processing illustrated in FIG. 6B is executed after the processing illustrated in FIG. 6A, the most appropriate color sheet can automatically be selected without requiring any special operation by a user. Furthermore, sheet color areas are not printed, whereby toner consumption can be reduced. While the foregoing exemplary embodiment describes the electrophotographic method as an example of the printing method and toner as an example of a recording material, the printing method may be an inkjet method and the recording material may be ink. In this case, the ink consumption can be reduced.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-268362 filed Dec. 7, 2012, which is hereby incorporated by reference herein in its entirety.

What is claimed is:

1. An image forming apparatus comprising:
a reading unit configured to read an image of a document;
a recognizing unit configured to recognize a background color of the image read by the reading unit;
a storage unit configured to store image data indicating the image read by the reading unit and the background color recognized by the recognizing unit;
a receiving unit configured to receive a processing request for execution of processing on the image data stored in the storage unit; and
a control unit configured to control execution of processing on the image data according to the processing request received by the receiving unit and the background color stored in the storage unit.

2. The image forming apparatus according to claim 1, wherein the control unit causes a display unit to display the image data with the background color when the processing request received by the receiving unit is a display request.

3. The image forming apparatus according to claim 1, wherein the control unit transmits the image data with the background color when the processing request received by the receiving unit is a transmission request.

4. The image forming apparatus according to claim 1, wherein the control unit performs control to print the image on a sheet of a color corresponding to the background color when an attribute of the processing request received by the receiving unit is a print request.

5. The image forming apparatus according to claim 4, wherein the control unit performs control to print the image while converting pixels, which are to be printed in the same color as the background color, into white pixels.

6. A control method for controlling an image forming apparatus, the control method comprising:
reading an image of a document;
recognizing a background color of the read image;
storing image data indicating the read image and the recognized background color;
receiving a processing request for execution of processing on the stored image data; and
controlling execution of processing on the image data according to the received processing request and the stored background color.

7. A computer-readable storage medium storing a computer program for controlling an image forming apparatus, the computer program comprising:
a code to read an image of a document;
a code to recognize a background color of the read image;
a code to store image data indicating the read image and the recognized background color;
a code to receive a processing request for execution of processing on the stored image data; and
a code to control execution of processing on the image data according to the received processing request and the stored background color.
